(19) United States
(12) Patent Application Publication
(10) Pub. No.: US 2025/0344044 A1
(43) Pub. Date: Nov. 6, 2025

(54) Methods and Devices for Shared Delivery of IP Multicast

(71) Applicant: Telefonaktiebolaget LM Ericsson (publ), Stockholm (SE)

(72) Inventors: David Ian Allan, Victoria (CA); Ziquan Pan, Beijing (CN)

(21) Appl. No.: 18/860,877

(22) PCT Filed: Apr. 29, 2022
(86) PCT No.: PCT/CN2022/090620

§ 371 Date: Oct. 28, 2024

(51) Int. Cl. H04W 4/06; H04L 5/00; H04L 12/18; H04L 12/46

(52) U.S. Cl. CPC H04W 4/06; H04L 5/0053; H04L 12/185; H04L 12/189; H04L 12/4633

(57) ABSTRACT

A method implemented by a first network node is provided. The method comprises: transmitting a first request for modification of a multicast broadcast service, MBS, associated packet data unit, PDU, session to a first function node; and receiving a first acknowledgement for the modification of the MBS associated PDU session and an access stratum, AS, PDU session parameter message from a second network node. This solution allows AN delivered multicast to be combined with the 5G control plane such that personalized policy and charging are possible.

### TECHNICAL FIELD The present disclosure generally relates to the field of communication, and more particularly to methods and devices for shared delivery of IP (internet protocol) multicast.

### BACKGROUND

This section introduces aspects that may facilitate better understanding of the present disclosure. Accordingly, the statements of this section are to be read in this light and are not to be understood as admissions about what is in the prior art or what is not in the prior art.

Wireless Wireline Convergence (WWC) seeks to converge wireline access onto a 5G core network.

One aspect not fully addressed by the standardization work on WWC to date is the delivery of linear IPTV. In existing wireline networks this may be delivered using multicast from the broadband network gateway (BNG) or via multicast delivered from the access node (AN). Multicast from the AN is the most efficient solution and is deployed by several operators.

5MBS (5G multicast broadcast service) is intended to provide multicast and broadcast services for the 5G system. For fixed wireless access that uses 5G radio as an alternative access to wireline, it will also be the only mechanism available for multicast services.

5MBS (TS 23.247) uses the following terms:

5GC (5^{th} generation core) Individual MBS traffic delivery: 5G CN (core network) receives a single copy of MBS data packets and delivers separate copies of those MBS data packets to individual UEs (user equipments) via per-UE PDU (packet data unit) sessions, hence for each such UE one PDU session is required to be associated with a multicast session.

5GC shared MBS traffic delivery: 5G CN receives a single copy of MBS data packets and delivers a single copy of those MBS data packets to a RAN node.

For WWC with AN based multicast and PON, there is the possibility of shared delivery and individual delivery in the access node, so the use of these terms in this disclosure is in the spirit of TS 23.247 but is generalized and also used outside the 5GS context:

Shared delivery
A single copy is sent on a physical or virtual (tunnel) link that ultimately may be delivered to multiple subscribers;

Individual delivery
A copy per subscriber is sent on a physical or virtual link.

In the existing deployment, wireline operators have deployed AN or BNG based multicast using IGMP (internet group management protocol) signalling to support linear IPTV services.

General mode of operation for AN based multicast is:
IGMP request sent by STB (set top box) and relayed by RG (residential gateway);
AN snoops request, performs access control, and summarizes valid requests onto the multicast VLAN (virtual local area area) using industry IGMP proxy behavior after rudimentary access control checks,
   the summarized IGMP loses identity;
AN may do proxy reporting to a BNG to support “bandwidth adjust” on a per subscriber basis,
   this must have some means of communicating RG identity and multicast group to a BNG so it knows the subscriber and the associated bandwidth profile.

BNG based multicast simply sees the BNG as the multicast router terminating subscriber IGMP requests.

5GS release 16 offers the equivalent of BNG based multicast. UPF (user plane function) terminates STB originated IGMP messages.

FIG. 1 illustrates a current architecture of the AN or BNG based multicast.

As to the linear IPTV and the 5G system, operators have expressed a desire to include Access Node delivered multicast for IPTV as part of convergence on the 5G system.

However this desire also includes not modifying deployed equipment.

The primary motive is efficiency as it significantly offloads traffic from BNGs, and it would be correspondingly true for AGF (access gateway function)/UPF deployments.

5MBS specified by 3GPP (3^{rd} generation partner project) for release 17 provides an opportunity to do this. It also introduce additional components to the architecture. They would be common to FWA (fixed wireless access), eMBB (enhanced Mobile Broadband) and WWC.

It is desirable to have a solution that maximizes commonality between wireline and FWA access and is easily adaptable to future extensions to the 5G system and is capable of leveraging AN delivered multicast in existing access networks without diminishing the value the policy and charging capabilities the 5G system offers.

### SUMMARY

One consideration driven by business requirements is that converged access to the 5G system may be retrofitted to deployed and unmodified access networks. This will include DSLAMs (digital subscriber line access multiplexers) for DSL access, and OLTs (optical line terminals) for PON (passive optical network)—fiber access. Many of these devices in the access network are either aged, or in restricted footprint implementations (such as pluggable modules) and are not amenable to upgrade. Further linear IPTV is a declining business which restricts the business case for system upgrade.

The existing system is based on IGMP originating at the set top box attached to the home LAN, which is relayed to the core network by the RG.

Several proposals have been discussed that do not use 5MBS but seek to exhibit similar properties. All have had serious operational flaws.

The solution uses both 5GS signalling procedures and legacy procedures in parallel such that the legacy components in the system can be coupled to the 5G procedures at the access gateway function (AGF) without actually modifying the legacy equipment.

The solution for integrating legacy AN based IPTV delivery into the 5G system using 5MBS is proposed herein. This solution works, whether 5MBS is deployed in wireline or not. This solution can be made to work with ATSSS (access traffic steering splitting and switching) or with multi-access handover, has common NAS procedures with FWA minimizing implementation variations for RGs, and confines changes to the wireline network (no changes to the 5GS N1, N2 or N3 interfaces).

According to a first aspect of the present disclosure, a method implemented by a first network node is provided. The method comprises: transmitting a first request for modification of a multicast broadcast service, MBS, associated packet data unit, PDU, session to a first function node; and receiving a first acknowledgement for the modification of the MBS associated PDU session and an access stratum, AS, PDU session parameter message from a second network node.

In an alternative embodiment of the first aspect, the AS PDU session parameter message may indicate use of an internet group management protocol, IGMP, and internet protocol over Ethernet, IPoE, encapsulation.

In another alternative embodiment of the first aspect, the AS PDU session parameter message may be a multicast parameter message including a multicast discriminator type, a multicast discriminator value and supplementary procedures.

In another alternative embodiment of the first aspect, the method may further comprise: prior to transmitting the first request, transmitting a second request for establishment of the MBS associated PDU session to the first function node; and receiving a second acknowledgement for the establishment of the MBS associated PDU session from the second network node.

In another alternative embodiment of the first aspect, the method may further comprise: after receiving the first acknowledgement, transmitting a third request for IGMP join to a third network node.

According to a second aspect of the present disclosure, a method implemented by a second network node is provided. The method comprises: adding subscribers to a multicast broadcast service, MBS, shared delivery session; and transmitting a first acknowledgement for modification of an MBS associated packet data unit, PDU, session and an access stratum, AS, PDU session parameter message to a first network node.

According to a third aspect of the present disclosure, a method implemented by a third network node is provided. The method comprises: receiving an internet group management protocol, IGMP, join request for a multiple group from a first network node; and adding a subscriber drop as a new leaf.

Accordingly to a fourth aspect of the present disclosure, a first network node is provided. The first network node comprises a processor and a memory communicatively coupled to the processor. The memory is adapted to store instructions which, when executed by the processor, cause the first network node to perform operations of the method according to the above first aspect.

According to a fifth aspect of the present disclosure, a first network node is provided. The first network node is adapted to perform the method of the above first aspect.

According to a sixth aspect of the present disclosure, a second network node is provided. The second network node comprises a processor and a memory communicatively coupled to the processor. The memory is adapted to store instructions which, when executed by the processor, cause the second network node to perform operations of the method according to the above second aspect.

According to a seventh aspect of the present disclosure, a second network node is provided. The second network node is adapted to perform the method of the above second aspect.

According to an eighth aspect of the present disclosure, a third network node is provided. The third network node comprises a processor and a memory communicatively coupled to the processor. The memory is adapted to store instructions which, when executed by the processor, cause the third network node to perform operations of the method according to the above third aspect.

According to a ninth aspect of the present disclosure, a third network node is provided. The third network node is adapted to perform the method of the above third aspect.

According to a tenth aspect of the present disclosure, a communication system is provided. The communication system comprises: a first network node of the above fourth or fifth aspect; a second network node of the above sixth or seventh aspect, communicating with at least the first network node; and a third network node of the eighth or ninth aspect, communicating with at least the first network node and the second network node.

According to an eleventh aspect of the present disclosure, a non-transitory computer readable medium having a computer program stored thereon is provided. When the computer program is executed by a set of one or more processors of a first network node, the computer program causes the first network node to perform operations of the method according to the above first aspect.

According to a twelfth aspect of the present disclosure, a non-transitory computer readable medium having a computer program stored thereon is provided. When the computer program is executed by a set of one or more processors of a second network node, the computer program causes the second network node to perform operations of the method according to the above second aspect.

According to a thirteenth aspect of the present disclosure, a non-transitory computer readable medium having a computer program stored thereon is provided. When the computer program is executed by a set of one or more processors of a third network node, the computer program causes the third network node to perform operations of the method according to the above third aspect.

This solution allows AN delivered multicast to be combined with the 5G control plane such that personalized policy and charging are possible. It also provides for a common NAS (non access stratum) stack and procedures in a 5G-RG for FWA, wireline or hybrid access, with the procedure modifications being confined exclusively to wireline access stratum handling.

### BRIEF DESCRIPTION OF THE DRAWINGS

The present disclosure may be best understood by way of example with reference to the following description and accompanying drawings that are used to illustrate embodiments of the present disclosure. In the drawings:

FIG. 1 is a diagram illustrating a current architecture of the AN or BNG based multicast;

FIG. 2 is a diagram illustrating an exemplary architecture of the AN based multicast according to an embodiment of the present disclosure;

FIG. 3 is a sequence diagram illustrating a call flow of shared delivery according to some embodiments of the present disclosure;

FIG. 4A is a diagram illustrating a current access stratum (AS) message;

FIG. 4B is a diagram illustrating a further type of AS message according an embodiment of the present disclosure;

FIG. 4C is a diagram illustrating contents of the multicast parameters message according to an embodiment of the present disclosure;

FIG. 5 a flow chart illustrating a method implemented on a first network node according to some embodiments of the present disclosure;

FIG. 6 is a flow chart illustrating a method implemented on a second network node according to some embodiments of the present disclosure;

FIG. 7 is a block diagram illustrating a method implemented on a third network node according to some embodiments of the present disclosure;

FIG. 8 is a block diagram illustrating a first network node according to some embodiments of the present disclosure;

FIG. 9 is another block diagram illustrating a first network node according to some embodiments of the present disclosure;

FIG. 10 is a block diagram illustrating a second network node according to some embodiments of the present disclosure;

FIG. 11 is another block diagram illustrating a second network node according to some embodiments of the present disclosure;

FIG. 12 is a block diagram illustrating a third network node according to some embodiments of the present disclosure;

FIG. 13 is another block diagram illustrating a third network node according to some embodiments of the present disclosure;

FIG. 14 is a block diagram illustrating a communication system according to some embodiments of the present disclosure;

FIG. 15 is a block diagram schematically illustrating a telecommunication network connected via an intermediate network to a host computer;

FIG. 16 is a generalized block diagram of a host computer communicating via a base station with a user equipment over a partially wireless connection; and

FIGS. 17 to 20 are flowcharts illustrating methods implemented in a communication system including a host computer, a base station and a user equipment.

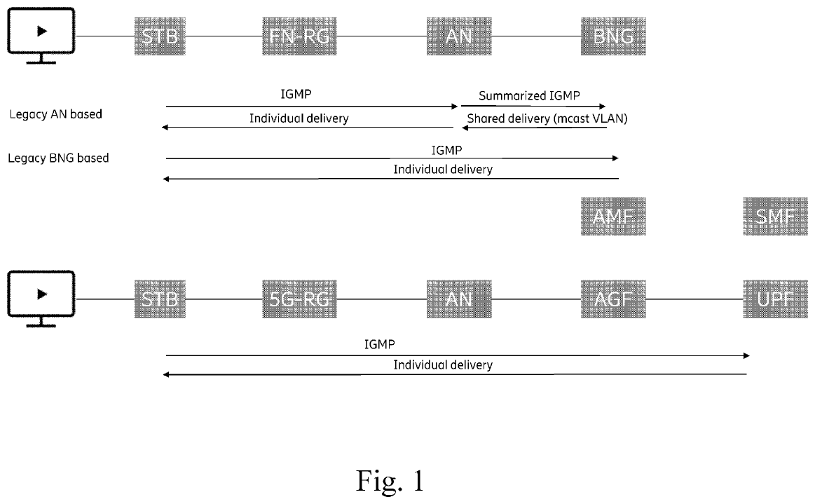

### DETAILED DESCRIPTION

The following detailed description describes methods and devices for shared delivery of IP multicast. In the following detailed description, numerous specific details such as logic implementations, types and interrelationships of system components, etc. are set forth in order to provide a more thorough understanding of the present disclosure. It should be appreciated, however, by one skilled in the art that the present disclosure may be practiced without such specific details. In other instances, control structures, circuits and instruction sequences have not been shown in detail in order not to obscure the present disclosure. Those of ordinary skill in the art, with the included descriptions, will be able to implement appropriate functionality without undue experimentation.

References in the specification to “one embodiment”, “an embodiment”, “an example embodiment” etc. indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

Bracketed text and blocks with dashed borders (e.g., large dashes, small dashes, dot-dash, and dots) may be used herein to illustrate optional operations that add additional features to embodiments of the present disclosure. However, such notation should not be taken to mean that these are the only options or optional operations, and/or that blocks with solid borders are not optional in certain embodiments of the present disclosure.

In the following detailed description and claims, the terms “coupled” and “connected,” along with their derivatives, may be used. It should be understood that these terms are not intended as synonyms for each other. “Coupled” is used to indicate that two or more elements, which may or may not be in direct physical or electrical contact with each other, cooperate or interact with each other. “Connected” is used to indicate the establishment of communication between two or more elements that are coupled with each other.

An electronic device stores and transmits (internally and/or with other electronic devices over a network) code (which is composed of software instructions and which is sometimes referred to as computer program code or a computer program) and/or data using machine-readable media (also called computer-readable media), such as machine-readable storage media (e.g., magnetic disks, optical disks, read only memory (ROM), flash memory devices, phase change memory) and machine-readable transmission media (also called a carrier) (e.g., electrical, optical, radio, acoustical or other forms of propagated signals—such as carrier waves, infrared signals). Thus, an electronic device (e.g., a computer) includes hardware and software, such as a set of one or more processors coupled to one or more machine-readable storage media to store code for execution on the set of processors and/or to store data. For instance, an electronic device may include non-volatile memory containing the code since the non-volatile memory can persist code/data even when the electronic device is turned off (when power is removed), and while the electronic device is turned on, that part of the code that is to be executed by the processor(s) of that electronic device is typically copied from the slower non-volatile memory into volatile memory (e.g., dynamic random access memory (DRAM), static random access memory (SRAM)) of that electronic device. Typical electronic devices also include a set of one or more physical network interfaces to establish network connections (to transmit and/or receive code and/or data using propagating signals) with other electronic devices. One or more parts of an embodiment of the present disclosure may be implemented using different combinations of software, firmware, and/or hardware.

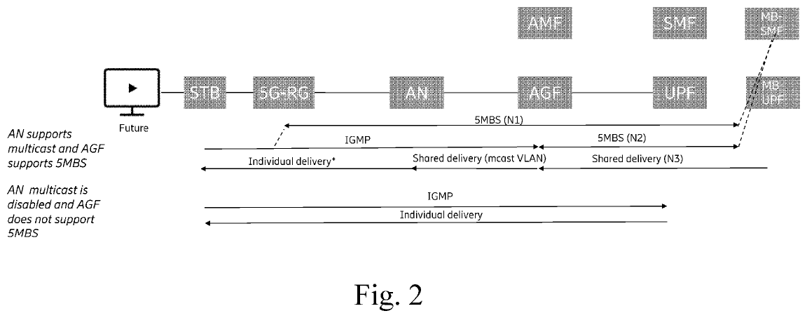

FIG. 2 illustrates an exemplary architecture of the AN based multicast according to an embodiment of the present disclosure.

It should be noted that it is possible for an AN to be integrated into an AGF so that there are deployment scenarios where the AN can be 5G “aware”. It is also possible to perform shared delivery between the AN and STB with PON systems.

Artifacts of attempting to integrate AN based multicast with the 5GS need to be local to the wireline system to avoid complicating the 5GS.

Joining and leaving 5MBS multicast group should use procedures and concepts common with wireless access. 5MBS for wireline needs to also support ATSSS and handover (HO) in the future, so maximizing alignment with 5MBS procedures should simplify the addition of this functionality.

In the future the AGF function may be integrated into access nodes (ANs) suggesting a different implementation, so flexibility is required in any design.

The present disclosure will work in deployments where shared delivery is not available or AGF does not support 5MBS procedures.

It would be possible to provide some support for IPoE (Internet Protocol over Ethernet) FN-RGs (fixed network-RGs) but without the full personalization that the 5GS offers. This is a consequence of IGMP summarization from the AN to the AGF, no visibility of individual FN-RGs, so individual subscriber management is using existing procedures.

In broad brush aspects, AGF has a proxy ID for requesting 5MBS services on behalf of the set of served FN-RGs. AGF splices shared delivery from the 5GS to the multicast VLAN to the AN. AGF receives a summarized IGMP from the AN. AGF performs 5MBS procedures using the proxy subscription to the 5GS to obtain multicast content. AGF provides a shared delivery feed to the AN who then replicates it to individual RG/STBs. RG uses normal PDU session to access FCC (fast channel change) server.

Deployed access nodes have no 5G capability. A multicast “join” at the AN is a consequence of STB initiated IGMP messages relayed by the RG. There is leaf initiated join (LIJ) via the user plane. There is no root initiated join (RIJ) capability to allow the network to control multicast.

IGMP can only be recognized by a legacy AN if delivered as raw IPoE frames. A legacy AN only does multicast replication of IPoE frames downstream, so there is no 5G metadata such as QFI and a UP session ID. However each multicast stream will have a unique multicast address

IGMP signalling uses IP multicast addresses to identify the multicast groups of interest.

Most IPTV systems are implemented as IPv4. As they are local to the access, there was never impetus to define an IPv6 version.

The present disclosure will make reference exclusively to IGMP procedures although MLD for IPv6 could be a perfectly valid embodiment.

Prior to 5MBS, numerous proposals were brought to the WWC study work to achieve shared delivery to an AGF. General form was using a single subscriber PDU session as the shared access session for multicast, which had very complicated procedures to elect another subscriber session should that specific subscriber leave the multicast group.

Since then, use of IGMP from the 5G-RG and having the AGF interworking IGMP with 5MBS was considered. This would have numerous complications: there are different implementations for wireline than wireless (not desirable); and AGF acting as proxy would not have 5G-RG credentials (believed to be a show stopper).

The preferred embodiment would be that the 5G RG used 5MBS NAS procedures as per the 5MBS architecture, and when the multicast delivery was set up, the access stratum part of session setup (where access specific aspects of communication channel configuration were communicated) would indicate to the 5G-RG that supplemental procedures and a different encapsulation would be required to establish access to shared delivery between the AGF and the AN. Therefore, a success reply to joining a multicast group would include additional information encoded as additional information in the access stratum signalling from the AGF to the 5G-RG:
1. An indication to use IGMP (IPv4) or MLD (dIPv6) encapsulated as IPoE as an additional non-5G signalling step; and
2. Multicast will be delivered as IPoE and not 5WE encapsulated.

As a pre-requisite, legacy Access Nodes (ANs) are typically pre-provisioned with an access control list for subscribers to indicate what TV channels/multicast groups the subscriber is entitled to access.

This provisioning would need to be interworked with the 5G system subscriber management.

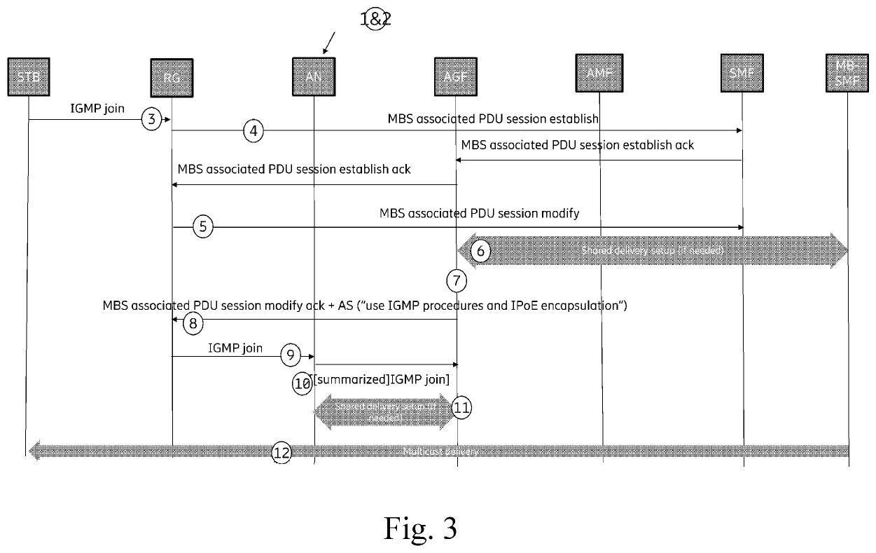

FIG. 3 is a sequence diagram illustrating a call flow of shared delivery according to some embodiments of the present disclosure.

At step 1, subscribers are provisioned with a set of multicast TV channels they are allowed to watch. At step 2, 5GS and legacy AN are provisioned with the list.

At step 3, 5G-RG receives IGMP from set top box (STB). At step 4, 5G-RG generates 5MBS PDU associate session initiation procedures. At step 5, 5G-RG uses session modify to request multicast using the IP multicast address obtained from IGMP. If not already present, 5MBS shared delivery session set up to the AGF at step 6.

At step 7, subscribers are added to the 5MBS shared delivery session at the AGF. At step 8, AGF uses AS PDU session parameters to instruct 5G-RG to use IGMP and that session encap will be raw IPoE.

At step 9, 5G-RG issues IGMP for multicast group.

At step 10, AN receives IGMP, and then perform one of the following two actions:
if it does not have the multicast group, issuing a join upstream and adding the subscriber drop as a new leaf;
if it does have the multicast group, simply adding the subscriber drop as a new leaf.

At step 11, AGF, when receiving a new IGMP join, maps it to the associated 5MBS session (which should exist apriori at that point). AGF needs to check if there is a valid client UE for the 5MBS multicast group before adding shared delivery to the AN.

Additional steps such as the STB accessing a fast channel change server to pre-fill playout buffers may occur in parallel with some of these procedures.

At step 12, multicast delivery begins.

It will be recognized that non-5G AN delivered multicast is simply an optimization local to the access and that the solution needs to accommodate both shared and individual delivery.

This allows for a desirable scenario whereby common procedures can be used with the 5G system and any modifications for integrating non-5G components can be local to the specific access type. It is confined to access stratum procedures for configuration which is purely a local matter between the 5G-RG and the AGF. In the general case (FWA and possibly AGF integrated with the AN), the above step 8 would simply indicate the specifics of multicast delivery (individual delivery direct from the AGF), and would not indicate that the additional steps (9&10) were needed to initiate multicast delivery and that there would be specific protocol details to be configured (use of IPoE).

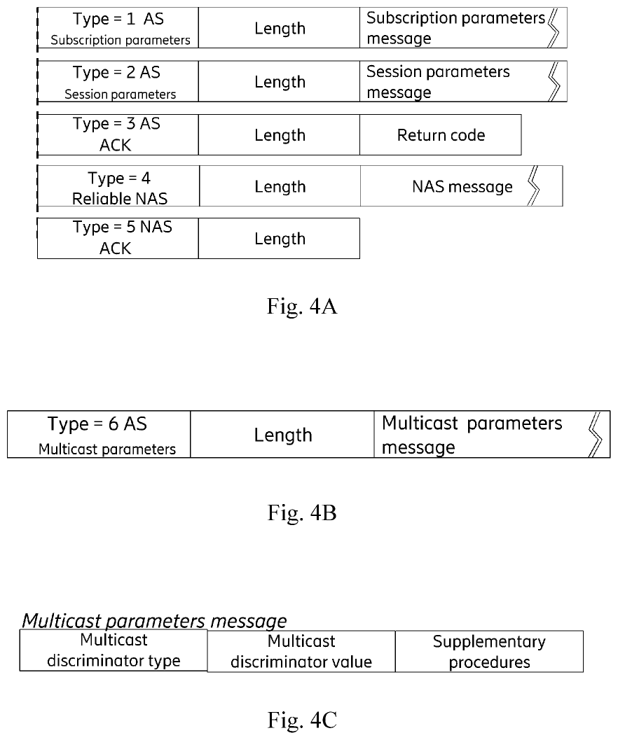

FIG. 4A is a diagram illustrating a current AS message. The AS message may be one of 5 specified TLVs (type length values).

FIG. 4B is a diagram illustrating a further type of AS message according an embodiment of the present disclosure. A sixth type of AS message includes multiple parameters message.

FIG. 4C is a diagram illustrating contents of the multicast parameters message according to an embodiment of the present disclosure. The multicast parameters message comprises a multicast discriminator type, a multicast discriminator value and supplementary procedures.

The multicast discriminator type indicates:
5WE (individual delivery UPF to 5G-RG and possibly AGF/AN integration with shared delivery to the AN/AGF)
IPoE (AN delivery).

The multicast discriminator value indicates:
Existing associate PDU session 5WE session ID for individual delivery
New 5WE session ID for AN/AGF integrated shared delivery
IP multicast address for IPoE (AN based shared delivery).

The supplementary procedures indicate:
0=none (for individual delivery and AN/AGF integrated shared delivery)
1=IGMP (for AN based shared delivery).

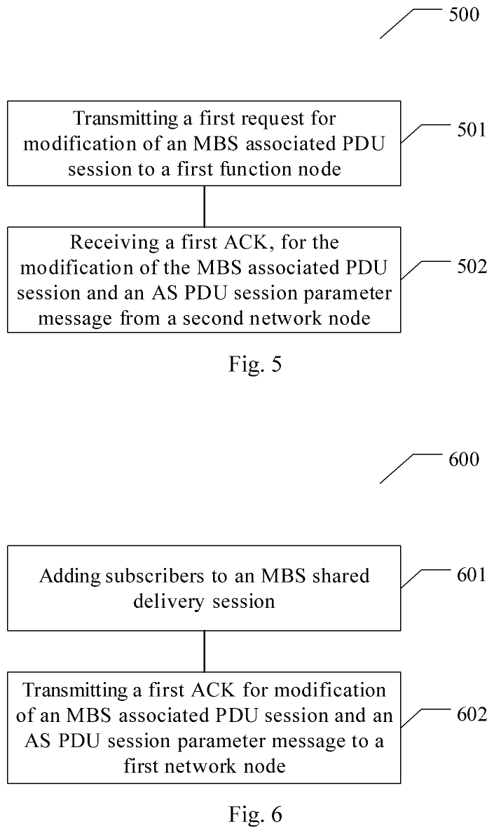

FIG. 5 is a flow chart illustrating a method 500 implemented on a first network node according to some embodiments of the present disclosure. As an example, operations of this flow chart may be performed by an RG such as the RG of FIG. 3, but they are not limited thereto. The operations in this and other flow charts will be described with reference to the exemplary embodiments of the other figures. However, it should be appreciated that the operations of the flow charts may be performed by embodiments of the present disclosure other than those discussed with reference to the other figures, and the embodiments of the present disclosure discussed with reference to these other figures may perform operations different than those discussed with reference to the flow charts.

In one embodiment, the first network node may transmit a first request for modification of an MBS associated PDU session to a first function node (block 501). The first network node may receive a first acknowledgement, ACK, for the modification of the MBS associated PDU session and an AS PDU session parameter message from a second network node (block 502).

As an example, the first function node may be an SMF, and the second network node may be an AGF.

As an example, the AS PDU session parameter message may indicate use of an IGMP and IPoE encapsulation.

As an example, the AS PDU session parameter message may be a multicast parameter message including a multicast discriminator type, a multicast discriminator value and supplementary procedures.

As an example, the method 500 may further comprise:
prior to transmitting the first request, transmitting a second request for establishment of the MBS associated PDU session to the first function node; and
receiving a second ACK for the establishment of the MBS associated PDU session from the second network node.

As an example, the method 500 may further comprise:
after receiving the first ACK, transmitting a third request for IGMP join to a third network node.

As a further example, the third network node may be an AN.

Furthermore, the present disclosure provides a first network node which is adapted to perform the method 500.

FIG. 6 is a flow chart illustrating a method 600 implemented on a second network node according to some embodiments of the present disclosure. As an example, operations of this flow chart may be performed by an AGF such as the AGF of FIG. 3.

In one embodiment, the second network node may add subscribers to an MBS shared delivery session (block 601). The second network node may transmit a first ACK for modification of an MBS associated PDU session and an AS PDU session parameter message to a first network node (block 602).

As an example, the first network node may be an RG.

As an example, the AS PDU session parameter message may indicate use of an IGMP and IPoE encapsulation.

As an example, the AS PDU session parameter message may be a multicast parameter message including a multicast discriminator type, a multicast discriminator value and supplementary procedures.

As an example, in the case that there is no MBS shared delivery session to the second network node, the MBS shared delivery session may be established between the second network node and a second function node.

As a further example, the second function node may be an MB-SMF.

As an example, the method 600 may further comprise:
receiving a second ACK for establishment of the MBS associated PDU session from a first function node; and
transmitting the second ACK to the first network node.

As a further example, the first function node may be an SMF.

As an example, the method 600 may further comprise:
receiving a summarized IGMP join request for a multicast group from a third network node;
mapping the summarized IGMP join request to the MBS shared delivery session;
checking whether there is a valid client for the multicast group; and
if so, establishing a shared delivery session with the third network node.

As a further example, the third network node may be an AN.

As an example, the second network node may be integrated with an AN.

Furthermore, the present disclosure provides a second network node which is adapted to perform the method 600.

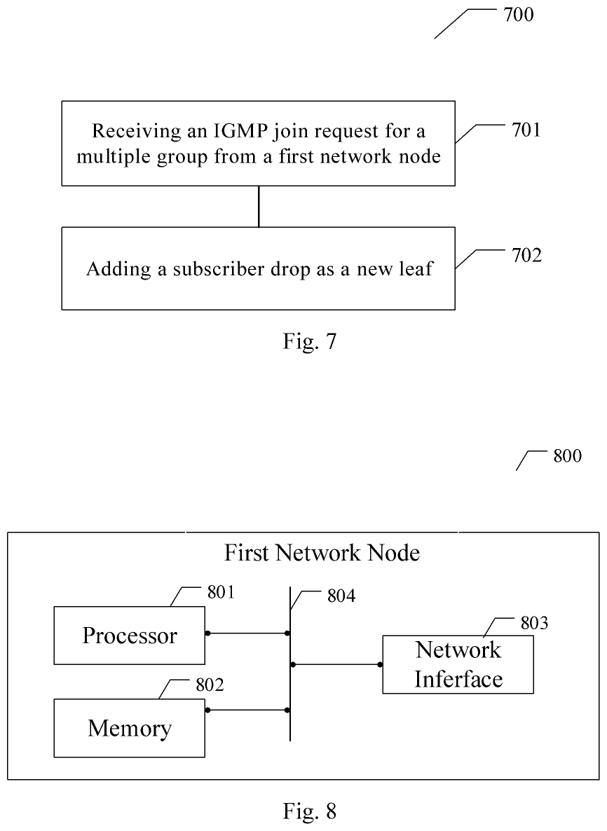

FIG. 7 is a flow chart illustrating a method 700 implemented on a third network node according to some embodiments of the present disclosure. As an example, operations of this flow chart may be performed by an AN such as the AN of FIG. 3.

In one embodiment, the third network node may receive an IGMP join request for a multiple group from a first network node (block 701). The third network node may add a subscriber drop as a new leaf (block 702).

As an example, the first network node may be an RG.

As an example, the method 700 may further comprise:
in the case that the third network node does not have the multicast group, transmitting a summarized IGMP join request for the multiple group to a second network node.

As a further example, the second network node may be an AGF.

As a further example, the method 700 may further comprise:
receiving a shared delivery session from the second network node.

Furthermore, the present disclosure provides a third network node which is adapted to perform the method 700.

FIG. 8 is a block diagram illustrating a first network node 800 according to some embodiments of the present disclosure. As an example, the first network node 800 may act as an RG such as the RG of FIG. 3, but it is not limited thereto. It should be appreciated that the first network node 800 may be implemented using components other than those illustrated in FIG. 8.

With reference to FIG. 8, the first network node 800 may comprise at least a processor 801, a memory 802, a network interface 803 and a communication medium 804. The processor 801, the memory 802 and the network interface 803 may be communicatively coupled to each other via the communication medium 804.

The processor 801 may include one or more processing units. A processing unit may be a physical device or article of manufacture comprising one or more integrated circuits that read data and instructions from computer readable media, such as the memory 802, and selectively execute the instructions. In various embodiments, the processor 801 may be implemented in various ways. As an example, the processor 801 may be implemented as one or more processing cores. As another example, the processor 801 may comprise one or more separate microprocessors. In yet another example, the processor 801 may comprise an application-specific integrated circuit (ASIC) that provides specific functionality. In still another example, the processor 801 may provide specific functionality by using an ASIC and/or by executing computer-executable instructions.

The memory 802 may include one or more computer-usable or computer-readable storage medium capable of storing data and/or computer-executable instructions. It should be appreciated that the storage medium is preferably a non-transitory storage medium.

The network interface 803 may be a device or article of manufacture that enables the first network node 800 to send data to or receive data from other devices. In different embodiments, the network interface 803 may be implemented in different ways. As an example, the network interface 803 may be implemented as an Ethernet interface, a token-ring network interface, a fiber optic network interface, a network interface (e.g., Wi-Fi, WiMax, etc.), or another type of network interface.

The communication medium 804 may facilitate communication among the processor 801, the memory 802 and the network interface 803. The communication medium 804 may be implemented in various ways. For example, the communication medium 804 may comprise a Peripheral Component Interconnect (PCI) bus, a PCI Express bus, an accelerated graphics port (AGP) bus, a serial Advanced Technology Attachment (ATA) interconnect, a parallel ATA interconnect, a Fiber Channel interconnect, a USB bus, a Small Computing System Interface (SCSI) interface, or another type of communications medium.

In the example of FIG. 8, the instructions stored in the memory 802 may include those that, when executed by the processor 801, cause the first network node 800 to implement the method described with respect to FIG. 5.

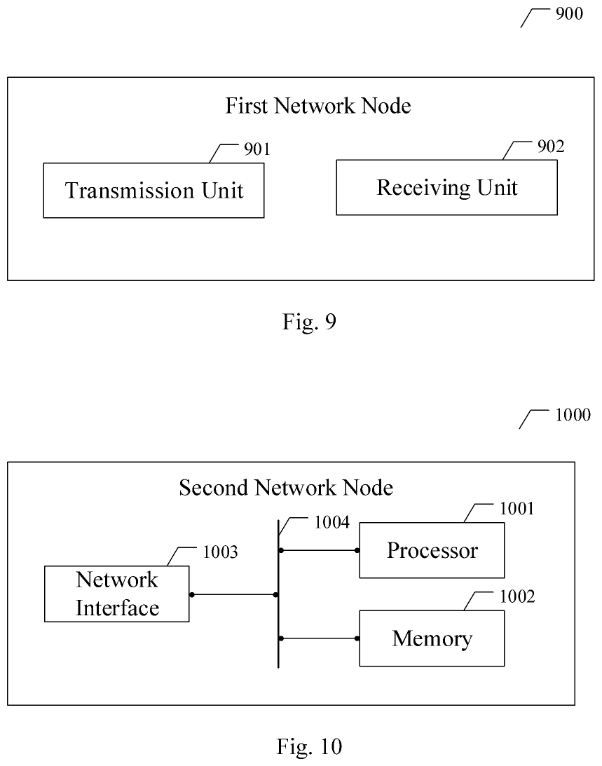

FIG. 9 is another block diagram illustrating a first network node 900 according to some embodiments of the present disclosure. As an example, the first network node 900 may act as an RG such as the RG of FIG. 3, but it is not limited thereto. It should be appreciated that the first network node 900 may be implemented using components other than those illustrated in FIG. 9.

With reference to FIG. 9, the first network node 900 may comprise at least a transmission unit 901 and a receiving unit 902. The transmission unit 901 may be adapted to perform at least the operation described in the block 501 of FIG. 5. The receiving unit 902 may be adapted to perform at least the operation described in the block 502 of FIG. 5.

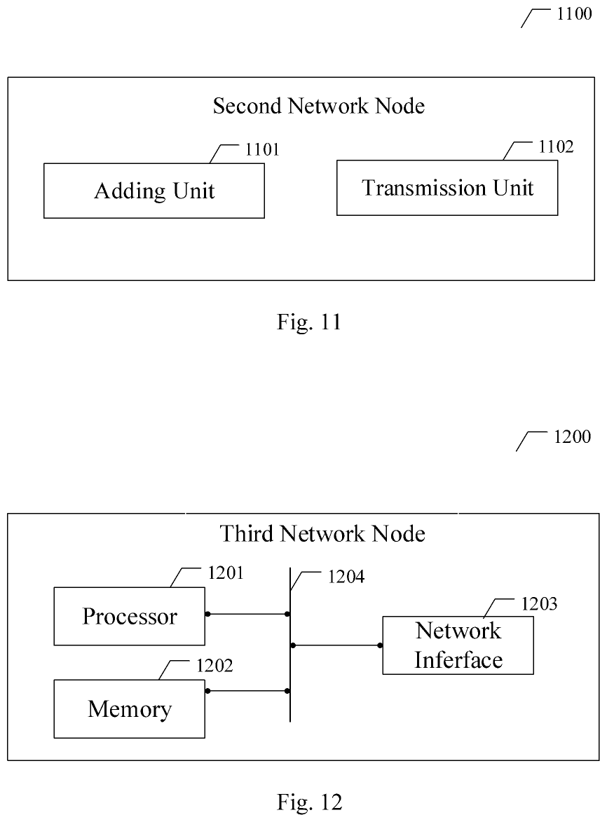

FIG. 10 is a block diagram illustrating a second network node 1000 according to some embodiments of the present disclosure. As an example, the second network node 1000 may be an AGF such as the AGF of FIG. 3, but it is not limited thereto. It should be appreciated that the second network node 1000 may be implemented using components other than those illustrated in FIG. 10.

With reference to FIG. 10, the second network node 1000 may comprise at least a processor 1001, a memory 1002, a network interface 1003 and a communication medium 1004. The processor 1001, the memory 1002 and the network interface 1003 are communicatively coupled to each other via the communication medium 1004.

The processor 1001, the memory 1002, the network interface 1003 and the communication medium 1004 are structurally similar to the processor 801, the memory 802, the network interface 803 and the communication medium 804 respectively, and will not be described herein in detail.

In the example of FIG. 10, the instructions stored in the memory 1002 may include those that, when executed by the processor 1001, cause the second network node 1000 to implement the method described with respect to FIG. 6.

FIG. 11 is another block diagram illustrating a second network node 1100 according to some embodiments of the present disclosure. As an example, the second network node 1100 may be an AGF such as the AGF of FIG. 3, but it is not limited thereto. It should be appreciated that the second network node 1100 may be implemented using components other than those illustrated in FIG. 11.

With reference to FIG. 11, the second network node 1100 may comprise at least an adding unit 1101 and a transmission unit 1102. The adding unit 1101 may be adapted to perform at least the operation described in the block 601 of FIG. 6. The transmission unit 1102 may be adapted to perform at least the operation described in the block 602 of FIG. 6.

FIG. 12 is a block diagram illustrating a third network node 1200 according to some embodiments of the present disclosure. As an example, the third network node 1200 may be an AN such as the AN of FIG. 3, but it is not limited thereto. It should be appreciated that the third network node 1200 may be implemented using components other than those illustrated in FIG. 12.

With reference to FIG. 12, the third network node 1200 may comprise at least a processor 1201, a memory 1202, a network interface 1203 and a communication medium 1204. The processor 1201, the memory 1202 and the network interface 1203 are communicatively coupled to each other via the communication medium 1204.

The processor 1201, the memory 1202, the network interface 1203 and the communication medium 1204 are structurally similar to the processor 801 or 1001, the memory 802 or 1002, the network interface 803 or 1003 and the communication medium 804 or 1004 respectively, and will not be described herein in detail.

In the example of FIG. 12, the instructions stored in the memory 1202 may include those that, when executed by the processor 1201, cause the third network node 1200 to implement the method described with respect to FIG. 7.

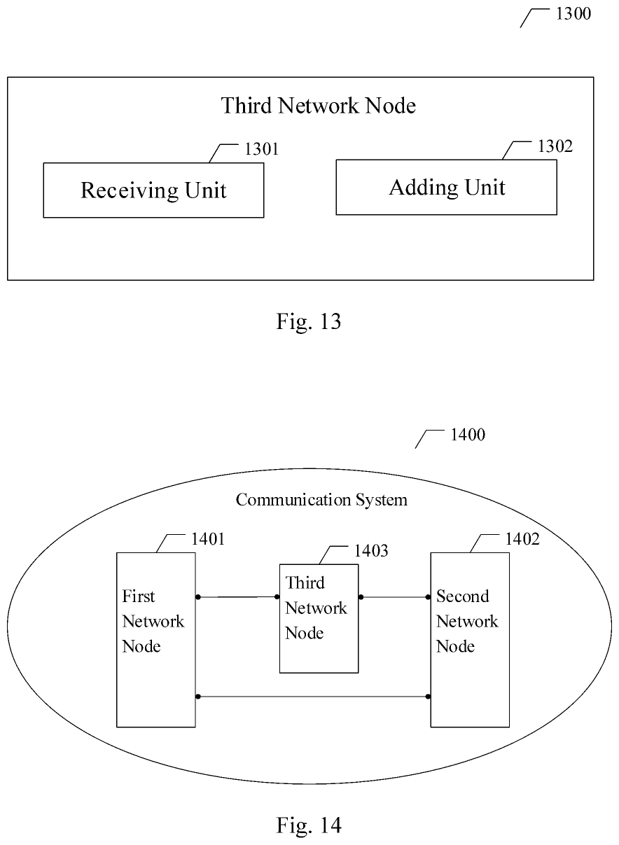

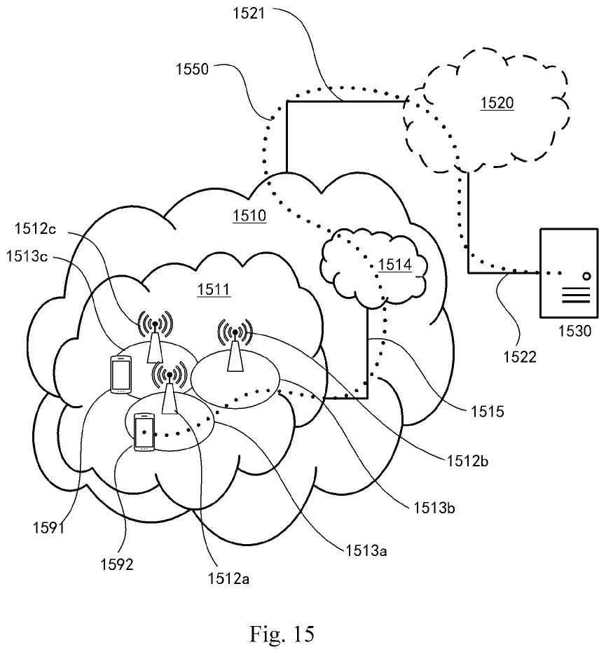

FIG. 13 is another block diagram illustrating a third network node 1200 according to some embodiments of the present disclosure. As an example, the third network node 1300 may be an AN such as the AN of FIG. 3, but it is not limited thereto. It should be appreciated that the third network node 1300 may be implemented using components other than those illustrated in FIG. 13.

With reference to FIG. 13, the third network node 1300 may comprise at least a receiving unit 1301 and an adding unit 1302. The receiving unit 1301 may be adapted to perform at least the operation described in the block 701 of FIG. 7. The adding unit 1302 may be adapted to perform at least the operation described in the block 702 of FIG. 7.

The units shown in FIGS. 9, 11 and 13 may constitute machine-executable instructions embodied within a machine, e.g., readable medium, which when executed by a machine will cause the machine to perform the operations described. Besides, any of these units may be implemented as hardware, such as an application specific integrated circuit (ASIC), Digital Signal Processor (DSP), Field Programmable Gate Array (FPGA) or the like.

Moreover, it should be appreciated that the arrangements described herein are set forth only as examples. Other arrangements (e.g., more controllers or more detectors, etc.) may be used in addition to or instead of those shown, and some units may be omitted altogether. Functionality and cooperation of these units are correspondingly described in more detail with reference to FIGS. 5-7.

FIG. 14 is a block diagram illustrating a communication system 1400 according to some embodiments of the present disclosure. The communication system 1400 may comprise at least a first network node 1401, a second network node 1402 and a third network node 1403. In one embodiment, the first network node 1401 may act as the first network node 800 or 900 as depicted in FIG. 8 or 9, the second network node 1402 may act as the second network node 1000 or 1100 as depicted in FIG. 10 or 11, and the third network node 1403 may act as the third network node 1200 or 1300 as depicted in FIG. 12 or 13. In one embodiment, the first network node 1401, the second network node 1402 and the third network node 1403 may communicate with each other.

FIG. 15 is a block diagram schematically illustrating a telecommunication network connected via an intermediate network to a host computer.

With reference to FIG. 15, in accordance with an embodiment, a communication system includes a telecommunication network 1510, such as a 3GPP-type cellular network, which comprises an access network 1511, such as a radio access network, and a core network 1514. The access network 1511 comprises a plurality of base stations 1512a, 1512b, 1512c, such as NBs, eNBs, gNBs or other types of wireless access points, each defining a corresponding coverage area 1513a, 1513b, 1513c. Each base station 1512a, 1512b, 1512c is connectable to the core network 1514 over a wired or wireless connection 1515. A first user equipment (UE) 1591 located in coverage area 1513c is configured to wirelessly connect to, or be paged by, the corresponding base station 1512c. A second UE 1592 in coverage area 1513a is wirelessly connectable to the corresponding base station 1512a. While a plurality of UEs 1591, 1592 are illustrated in this example, the disclosed embodiments are equally applicable to a situation where a sole UE is in the coverage area or where a sole UE is connecting to the corresponding base station 1512.

The telecommunication network 1510 is itself connected to a host computer 1530, which may be embodied in the hardware and/or software of a standalone server, a cloud-implemented server, a distributed server or as processing resources in a server farm. The host computer 1530 may be under the ownership or control of a service provider, or may be operated by the service provider or on behalf of the service provider. The connections 1521, 1522 between the telecommunication network 1510 and the host computer 1530 may extend directly from the core network 1514 to the host computer 1530 or may go via an optional intermediate network 1520. The intermediate network 1520 may be one of, or a combination of more than one of, a public, private or hosted network; the intermediate network 1520, if any, may be a backbone network or the Internet; in particular, the intermediate network 1520 may comprise two or more sub-networks (not shown).

The communication system of FIG. 15 as a whole enables connectivity between one of the connected UEs 1591, 1592 and the host computer 1530. The connectivity may be described as an over-the-top (OTT) connection 1550. The host computer 1530 and the connected UEs 1591, 1592 are configured to communicate data and/or signaling via the OTT connection 1550, using the access network 1511, the core network 1514, any intermediate network 1520 and possible further infrastructure (not shown) as intermediaries. The OTT connection 1550 may be transparent in the sense that the participating communication devices through which the OTT connection 1550 passes are unaware of routing of uplink and downlink communications. For example, a base station 1512 may not or need not be informed about the past routing of an incoming downlink communication with data originating from a host computer 1530 to be forwarded (e.g., handed over) to a connected UE 1591. Similarly, the base station 1512 need not be aware of the future routing of an outgoing uplink communication originating from the UE 1591 towards the host computer 1530.

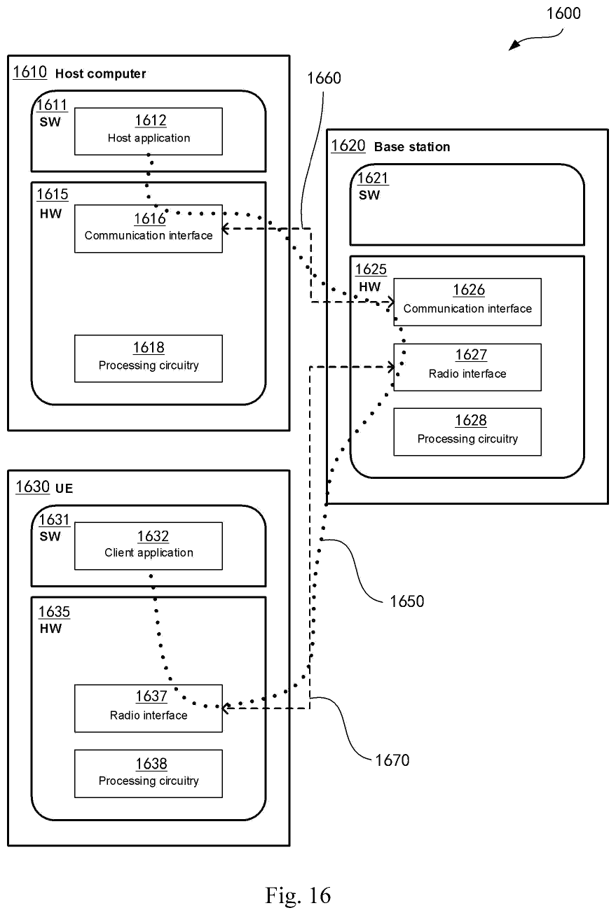

Example implementations, in accordance with an embodiment, of the UE, base station and host computer discussed in the preceding paragraphs will now be described with reference to FIG. 16. In a communication system 1600, a host computer 1610 comprises hardware 1615 including a communication interface 1616 configured to set up and maintain a wired or wireless connection with an interface of a different communication device of the communication system 1600. The host computer 1610 further comprises processing circuitry 1618, which may have storage and/or processing capabilities. In particular, the processing circuitry 1618 may comprise one or more programmable processors, application-specific integrated circuits, field programmable gate arrays or combinations of these (not shown) adapted to execute instructions. The host computer 1610 further comprises software 1611, which is stored in or accessible by the host computer 1610 and executable by the processing circuitry 1618. The software 1611 includes a host application 1612. The host application 1612 may be operable to provide a service to a remote user, such as a UE 1630 connecting via an OTT connection 1650 terminating at the UE 1630 and the host computer 1610. In providing the service to the remote user, the host application 1612 may provide user data which is transmitted using the OTT connection 1650.

The communication system 1600 further includes a base station 1620 provided in a telecommunication system and comprising hardware 1625 enabling it to communicate with the host computer 1610 and with the UE 1630. The hardware 1625 may include a communication interface 1626 for setting up and maintaining a wired or wireless connection with an interface of a different communication device of the communication system 1600, as well as a radio interface 1627 for setting up and maintaining at least a wireless connection 1670 with a UE 1630 located in a coverage area (not shown in FIG. 16) served by the base station 1620. The communication interface 1626 may be configured to facilitate a connection 1660 to the host computer 1610. The connection 1660 may be direct or it may pass through a core network (not shown in FIG. 16) of the telecommunication system and/or through one or more intermediate networks outside the telecommunication system. In the embodiment shown, the hardware 1625 of the base station 1620 further includes processing circuitry 1628, which may comprise one or more programmable processors, application-specific integrated circuits, field programmable gate arrays or combinations of these (not shown) adapted to execute instructions. The base station 1620 further has software 1621 stored internally or accessible via an external connection.

The communication system 1600 further includes the UE 1630 already referred to. Its hardware 1635 may include a radio interface 1637 configured to set up and maintain a wireless connection 1670 with a base station serving a coverage area in which the UE 1630 is currently located. The hardware 1635 of the UE 1630 further includes processing circuitry 1638, which may comprise one or more programmable processors, application-specific integrated circuits, field programmable gate arrays or combinations of these (not shown) adapted to execute instructions. The UE 1630 further comprises software 1631, which is stored in or accessible by the UE 1630 and executable by the processing circuitry 1638. The software 1631 includes a client application 1632. The client application 1632 may be operable to provide a service to a human or non-human user via the UE 1630, with the support of the host computer 1610. In the host computer 1610, an executing host application 1612 may communicate with the executing client application 1632 via the OTT connection 1650 terminating at the UE 1630 and the host computer 1610. In providing the service to the user, the client application 1632 may receive request data from the host application 1612 and provide user data in response to the request data. The OTT connection 1650 may transfer both the request data and the user data. The client application 1632 may interact with the user to generate the user data that it provides.

It is noted that the host computer 1610, base station 1620 and UE 1630 illustrated in FIG. 16 may be identical to the host computer 1530, one of the base stations 1512a, 1512b, 1512c and one of the UEs 1591, 1592 of FIG. 15, respectively. This is to say, the inner workings of these entities may be as shown in FIG. 16 and independently, the surrounding network topology may be that of FIG. 15.

In FIG. 16, the OTT connection 1650 has been drawn abstractly to illustrate the communication between the host computer 1610 and the use equipment 1630 via the base station 1620, without explicit reference to any intermediary devices and the precise routing of messages via these devices. Network infrastructure may determine the routing, which it may be configured to hide from the UE 1630 or from the service provider operating the host computer 1610, or both. While the OTT connection 1650 is active, the network infrastructure may further take decisions by which it dynamically changes the routing (e.g., on the basis of load balancing consideration or reconfiguration of the network).

The wireless connection 1670 between the UE 1630 and the base station 1620 is in accordance with the teachings of the embodiments described throughout this disclosure. One or more of the various embodiments improve the performance of OTT services provided to the UE 1630 using the OTT connection 1650, in which the wireless connection 1670 forms the last segment. More precisely, the teachings of these embodiments may improve the radio resource utilization and thereby provide benefits such as reduced user waiting time.

A measurement procedure may be provided for the purpose of monitoring data rate, latency and other factors on which the one or more embodiments improve. There may further be an optional network functionality for reconfiguring the OTT connection 1650 between the host computer 1610 and UE 1630, in response to variations in the measurement results. The measurement procedure and/or the network functionality for reconfiguring the OTT connection 1650 may be implemented in the software 1611 of the host computer 1610 or in the software 1631 of the UE 1630, or both. In embodiments, sensors (not shown) may be deployed in or in association with communication devices through which the OTT connection 1650 passes; the sensors may participate in the measurement procedure by supplying values of the monitored quantities exemplified above, or supplying values of other physical quantities from which software 1611, 1631 may compute or estimate the monitored quantities. The reconfiguring of the OTT connection 1650 may include message format, retransmission settings, preferred routing etc.; the reconfiguring need not affect the base station 1620, and it may be unknown or imperceptible to the base station 1620. Such procedures and functionalities may be known and practiced in the art. In certain embodiments, measurements may involve proprietary UE signaling facilitating the host computer's 1610 measurements of throughput, propagation times, latency and the like. The measurements may be implemented in that the software 1611, 1631 causes messages to be transmitted, in particular empty or ‘dummy’ messages, using the OTT connection 1650 while it monitors propagation times, errors etc.

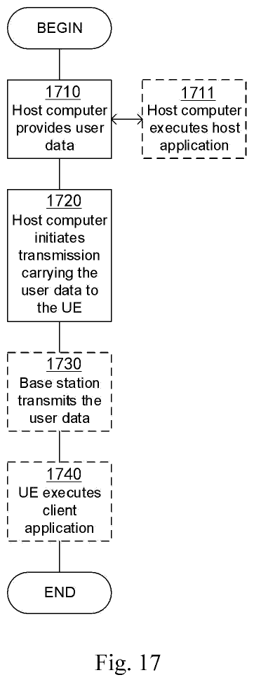

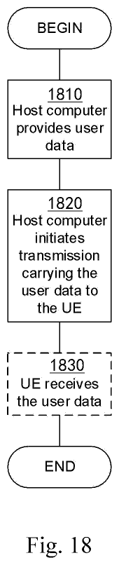

FIG. 17 is a flowchart illustrating a method implemented in a communication system, in accordance with one embodiment. The communication system includes a host computer, a base station and a UE which may be those described with reference to FIGS. 15 and 16. For simplicity of the present disclosure, only drawing references to FIG. 17 will be included in this section. In a first step 1710 of the method, the host computer provides user data. In an optional substep 1711 of the first step 1710, the host computer provides the user data by executing a host application. In a second step 1720, the host computer initiates a transmission carrying the user data to the UE. In an optional third step 1730, the base station transmits to the UE the user data which was carried in the transmission that the host computer initiated, in accordance with the teachings of the embodiments described throughout this disclosure. In an optional fourth step 1740, the UE executes a client application associated with the host application executed by the host computer.

FIG. 18 is a flowchart illustrating a method implemented in a communication system, in accordance with one embodiment. The communication system includes a host computer, a base station and a UE which may be those described with reference to FIGS. 15 and 16. For simplicity of the present disclosure, only drawing references to FIG. 18 will be included in this section. In a first step 1810 of the method, the host computer provides user data. In an optional substep (not shown) the host computer provides the user data by executing a host application. In a second step 1820, the host computer initiates a transmission carrying the user data to the UE. The transmission may pass via the base station, in accordance with the teachings of the embodiments described throughout this disclosure. In an optional third step 1830, the UE receives the user data carried in the transmission.

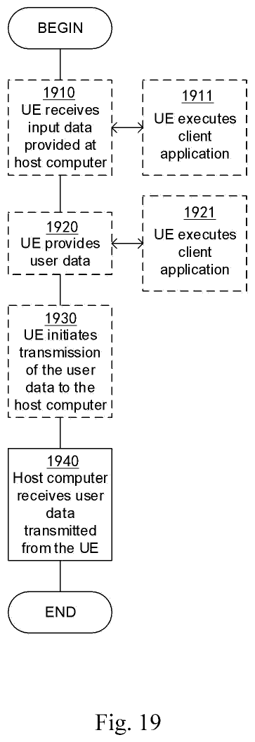

FIG. 19 is a flowchart illustrating a method implemented in a communication system, in accordance with one embodiment. The communication system includes a host computer, a base station and a UE which may be those described with reference to FIGS. 15 and 16. For simplicity of the present disclosure, only drawing references to FIG. 19 will be included in this section. In an optional first step 1910 of the method, the UE receives input data provided by the host computer. Additionally or alternatively, in an optional second step 1920, the UE provides user data. In an optional substep 1921 of the second step 1920, the UE provides the user data by executing a client application. In a further optional substep 1911 of the first step 1910, the UE executes a client application which provides the user data in reaction to the received input data provided by the host computer. In providing the user data, the executed client application may further consider user input received from the user. Regardless of the specific manner in which the user data was provided, the UE initiates, in an optional third substep 1930, transmission of the user data to the host computer. In a fourth step 1940 of the method, the host computer receives the user data transmitted from the UE, in accordance with the teachings of the embodiments described throughout this disclosure.

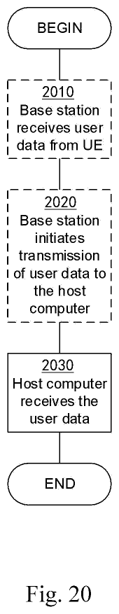

FIG. 20 is a flowchart illustrating a method implemented in a communication system, in accordance with one embodiment. The communication system includes a host computer, a base station and a UE which may be those described with reference to FIGS. 15 and 16. For simplicity of the present disclosure, only drawing references to FIG. 20 will be included in this section. In an optional first step 2010 of the method, in accordance with the teachings of the embodiments described throughout this disclosure, the base station receives user data from the UE. In an optional second step 2020, the base station initiates transmission of the received user data to the host computer. In a third step 2030, the host computer receives the user data carried in the transmission initiated by the base station.

Some portions of the foregoing detailed description have been presented in terms of algorithms and symbolic representations of transactions on data bits within a computer memory. These algorithmic descriptions and representations are ways used by those skilled in the data processing arts to most effectively convey the substance of their work to others skilled in the art. An algorithm is here, and generally, conceived to be a self-consistent sequence of transactions leading to a desired result. The transactions are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be appreciated, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “processing” or “computing” or “calculating” or “determining” or “displaying” or the like, refer to actions and processes of a computer system, or a similar electronic computing device, that manipulates and transforms data represented as physical (electronic) quantities within the computer system's registers and memories into other data similarly represented as physical quantities within the computer system memories or registers or other such information storage, transmission or display devices.

The algorithms and displays presented herein are not inherently related to any particular computer or other apparatus. Various general-purpose systems may be used with programs in accordance with the teachings herein, or it may prove convenient to construct more specialized apparatus to perform the required method transactions. The required structure for a variety of these systems will appear from the description above. In addition, embodiments of the present disclosure are not described with reference to any particular programming language. It should be appreciated that a variety of programming languages may be used to implement the teachings of embodiments of the present disclosure as described herein.

An embodiment of the present disclosure may be an article of manufacture in which a non-transitory machine-readable medium (such as microelectronic memory) has stored thereon instructions (e.g., computer code) which program one or more data processing components (generically referred to here as a “processor”) to perform the operations described above. In other embodiments, some of these operations might be performed by specific hardware components that contain hardwired logic (e.g., dedicated digital filter blocks and state machines). Those operations might alternatively be performed by any combination of programmed data processing components and fixed hardwired circuit components.

In the foregoing detailed description, embodiments of the present disclosure have been described with reference to specific exemplary embodiments thereof. It will be evident that various modifications may be made thereto without departing from the spirit and scope of the present disclosure as set forth in the following claims. The specification and drawings are, accordingly, to be regarded in an illustrative sense rather than a restrictive sense.

Throughout the description, some embodiments of the present disclosure have been presented through flow diagrams. It should be appreciated that the order of transactions and transactions described in these flow diagrams are only intended for illustrative purposes and not intended as a limitation of the present disclosure. One having ordinary skill in the art would recognize that variations can be made to the flow diagrams without departing from the spirit and scope of the present disclosure as set forth in the following claims.

1-28. (canceled)

29. A method implemented by a first network node, the method comprising:
transmitting a first request for modification of a multicast broadcast service (MBS) associated packet data unit (PDU) session to a first function node; and
receiving a first acknowledgement for the modification of the MBS associated PDU session and an access stratum (AS) PDU session parameter message from a second network node.

30. The method of claim 29, wherein the AS PDU session parameter message indicates use of an internet group management protocol (IGMP) and internet protocol over Ethernet (IPoE) encapsulation.

31. The method of claim 29, wherein the AS PDU session parameter message is a multicast parameter message including a multicast discriminator type, a multicast discriminator value and supplementary procedures.

32. The method of claim 29, further comprising:
prior to transmitting the first request, transmitting a second request for establishment of the MBS associated PDU session to the first function node; and
receiving a second acknowledgement for the establishment of the MBS associated PDU session from the second network node.

33. The method of claim 29, further comprising:
after receiving the first acknowledgement, transmitting a third request for IGMP join to a third network node.

34. The method of claim 29, wherein the first network node is a residential gateway, the first function node is a session management function, and the second network node is an access gateway function.

35. A method implemented by a second network node, the method comprising:
adding subscribers to a multicast broadcast service (MBS) shared delivery session; and
transmitting a first acknowledgement for modification of an MBS associated packet data unit (PDU) session and an access stratum (AS) PDU session parameter message to a first network node.

36. The method of claim 35, wherein the AS PDU session parameter message indicates use of an internet group management protocol (IGMP) and internet protocol over Ethernet (IPoE) encapsulation.

37. The method of claim 35, wherein the AS PDU session parameter message is a multicast parameter message including a multicast discriminator type, a multicast discriminator value and supplementary procedures.

38. The method of claim 35, wherein in the case that there is no MBS shared delivery session to the second network node, the MBS shared delivery session is established between the second network node and a second function node.

39. The method of claim 35, further comprising:
receiving a second acknowledgement for establishment of the MBS associated PDU session from a first function node; and
transmitting the second acknowledgement to the first network node.

40. The method of claim 35, further comprising:
receiving a summarized IGMP join request for a multicast group from a third network node;
mapping the summarized IGMP join request to the MBS shared delivery session;
checking whether there is a valid client for the multicast group; and
if so, establishing a shared delivery session with the third network node.

41. The method of claim 35, wherein the second network node is integrated with a third network node which is an access node.

42. A method implemented by a third network node, the method comprising:
receiving an internet group management protocol (IGMP) join request for a multiple group from a first network node; and
adding a subscriber drop as a new leaf.

43. The method of claim 42, further comprising:
in the case that the third network node does not have the multicast group, transmitting a summarized IGMP join request for the multiple group to a second network node.

44. The method of claim 43, further comprising:
receiving a shared delivery session from the second network node.

45. The method of claim 42, wherein the third network node is an access node, and the first network node is a residential gateway.

46. A first network node, comprising:
a processor; and
a memory communicatively coupled to the processor and adapted to store instructions which, when executed by the processor, cause the first network node to:
transmit a first request for modification of a multicast broadcast service (MBS) associated packet data unit (PDU) session to a first function node; and
receive a first acknowledgement for the modification of the MBS associated PDU session and an access stratum (AS) PDU session parameter message from a second network node.

47. A second network node, comprising:
a processor; and
a memory communicatively coupled to the processor and adapted to store instructions which, when executed by the processor, cause the second network node to:
add subscribers to a multicast broadcast service (MBS) shared delivery session; and
transmit a first acknowledgement for modification of an MBS associated packet data unit (PDU) session and an access stratum (AS) PDU session parameter message to a first network node.

48. A third network node, comprising:
a processor; and
a memory communicatively coupled to the processor and adapted to store instructions which, when executed by the processor, cause the third network node to:
receive an internet group management protocol (IGMP) join request for a multiple group from a first network node; and
add a subscriber drop as a new leaf.
